(19) United States
(12) Patent Application Publication
(10) Pub. No.: US 2017/0086511 A1
(43) Pub. Date: Mar. 30, 2017

(54) Pants With Utility Pocket

(71) Applicant: Earl E Hall, Fresno, CA (US)

(72) Inventor: Earl E Hall, Fresno, CA (US)

(21) Appl. No.: 14/869,392

(22) Filed: Sep. 29, 2015

(51) Int. Cl. A41D 1/06; B26B 1/02; A41D 27/20

(52) U.S. Cl. CPC A41D 1/06; A41D 27/201; B26B 1/02

(57) ABSTRACT

The present invention is a pair of pants having an upper waist area with two front pockets and two back pockets, and at least one additional utility pocket provided on one or both sides of the pants between the front and back pockets thereof, the additional pocket having a narrow top opening and an elongated interior to accommodate a small narrow object such as a pocket knife.

### BACKGROUND OF THE INVENTION

A. Field of the Invention

The field of the present invention relates generally to devices for carrying a pocket knife in the most efficient manner. More particularly, this invention relates to clothing with one or more pockets that are specifically fitted for efficiently carrying a pocket knife or other narrow item. Even more particularly, the present invention relates to pants having a specially configured pocket that is designed for carrying a pocket knife which allows the knife to be carried comfortably while preventing the knife from easily falling out of the pocket.

B. Description of the Prior Art

As is well known, pocket knives are common to a wide range of users in a variety of different cultures. Knives originated thousands of years ago, and were first used for hunting food, protection and other means of survival. Over time, the knife has evolved into several variations. One common variation of the knife has a handle with a fixedly attached, outwardly extending knife blade with one or more cutting edges. However, as is obvious, carrying this type of knife throughout the day is not practical or safe without a sheath or other type of carrying device suitable for receiving the knife blade and providing a means for holding the sheath on the person (i.e., on his or her belt, etc.). A common variation of the knife is the folding pocket knife. Like most other variations of knives, the typical pocket knife is configured for multiple uses. In addition, it has the added benefit of being easily and safely portable. Thus, the pocket knife carries all the benefits of a standard, fixed blade knife in a portable style that enables it to be carried in a more safe and practical manner.

With the complexity of our present time, the pocket knife has many more uses in today's daily lives than the standard knife did years ago. In fact, the pocket knife is considered a practical everyday tool for all types of people. A few of the numerous uses of a pocket knife include safety, various work fields (electrical, carpentry, etc.), outdoor sports (hiking, fishing, etc.), and daily purposes (peeling fruit, cutting loose threads, etc.). As such, many people consider the pocket knife to be an important functional component of their work and/or lifestyle.

To carry a pocket knife throughout the day seems simple. The size and foldability of the pocket knife give it its name. Generally, a user has several options when carrying the pocket knife, including carrying the knife in a bag or satchel, in a case specifically created for a pocket knife or in a purse. However, these options do not promote a situation by which the pocket knife can be easily and quickly accessible, thus defeating on of the primary advantages of carrying a pocket knife. Also, these options are susceptible to the situation where a satchel, bag, case, or purse may be lost, stolen, or forgotten at a place not so near to oneself at the time of need. A preferred option for many people for carrying a pocket knife is to carry the knife in a pocket of an item of clothing that is being worn. Because many people wear pants when in situations where it is beneficial to carry and utilize a pocket knife, it is particularly beneficial to carry the pocket knife in the pocket of a pair of pants that are worn by the user.

Although the pocket of a pair of pants that the user is wearing is the most sensible of the clothing carrying options for carrying a pocket knife, there are still flaws to carrying a pocket knife in a pocket. For example, when the user is carrying a pocket knife in his or her front or back pocket while sitting down, it is possible for the pocket knife to fall out of the pocket because the pocket is either too large or too loose to secure the pocket knife therein. Another problem with carrying the pocket knife in a pocket arises the situation where the user is walking briskly or running and the pocket knife is contained loosely in the pocket. The increased range of movement and speed of the user can result in the pocket knife falling out of the pocket. Yet another problem with carrying a pocket knife in your pocket while sitting is discomfort. In many situations, the pocket knife may move to a position where it stabs or pokes into the user's thigh, buttocks or other areas of the body. In addition, when the user carries a pocket knife in one of his or her regular pockets, which may also contain objects such as keys, cell phone, paper or coin money and/or other objects, the user is not likely to be able to quickly and efficiently grasp the pocket knife when the situation arises. In some cases, the problems and inefficiency of the above may cause a user to not carry the pocket knife on a daily or regular basis despite his or her desire to carry the knife.

With consideration to the aforementioned problems with regard to a user carrying a pocket knife in his or her pants pocket, as presently configured, it is still the most sensible way for a pocket knife user to carry a pocket knife. What is needed, therefore, is improved clothing with a specially configured pocket knife pocket that solves the problems described above. The preferred clothing item should be configured to provide a common and convenient piece of clothing, such as a pair of pants, with a utility pocket for improved accessibility and carrying of a pocket knife The preferred utility pocket should be configured to provide the pocket knife user with an efficient and comfortable means of carrying a pocket knife. The preferred utility pocket should be positioned on the pants such that when the pocket knife user sits down, the pocket knife neither falls out nor stabs or pokes the user in an uncomfortable manner. In addition, the preferred utility pocket should be shaped for the pocket knife to fit securely therein so that even when the user is in a fast and wide range of movement, such as when he or she is running, the pocket knife will remain secured in the pocket. Additionally, the preferred utility pocket should be positioned on the clothing such that the pocket knife is easily and quickly accessible by the wearer of the pants. Preferably, the utility pocket for carrying a pocket knife is adaptable for a wide variety of different types and styles of pants.

### SUMMARY OF THE INVENTION

The present invention provides pants with one or more utility pocket(s) for improved accessibility and carrying of a pocket knife or other small narrow object which provides the benefits and solves the problems identified above. In particular, the present invention discloses an improved utility pant pocket that provides an improved option for carrying a pocket knife or other narrow object in a secure and efficient manner. The utility pocket of the present invention is configured to be generally economical and to be used on pants in a manner that does not interfere with the wearer's normal style or daily functions. The improved utility pocket allows the user to better utilize a pocket knife or other narrow object when carried throughout the day. The improved utility pocket also creates a more accessible and convenient alternative to obtaining the pocket knife or other narrow object in one's hand.

In a preferred embodiment, one or two pockets may be provided. Each pocket is located on a side of the pant leg, between the front and back pockets. Each pocket includes a small top opening and a larger internal cavity. In preferred embodiments the pocket cavity itself is elongated and narrow, in order to snugly accommodate a narrow object such as a pocket knife. The size of the top opening is preferably narrow, but may be wider, it being limited only by the size positions of the front and back pockets of the pants. The internal cavity may be of any suitable shape, and may be longer and wider in order to accommodate objects larger than a pocket knife.

It is to be appreciated that the pocket(s) of the present invention may be used to carry other small, narrow objects that also may tend to fall out of the front or back pockets of a user's pants including without limitation, such items as: a ruler, pen, pencil, marker, laser pointer, stylus, eyeglasses, personal care items (nail clippers, nail file, makeup, lipstick, lip balm, mascara, etc.), mace, pepper spray, and the like.

### BRIEF DESCRIPTION OF THE DRAWINGS

Included with this disclosure are various figures which illustrate one of the preferred embodiments of the improved utility pocket of the present invention.

FIG. 1 is a front exterior view of an embodiment of the present invention showing a pair of pants having a single utility pocket thereon located on the right side of the pants.

FIG. 2 is a side exterior view of the embodiment shown in FIG. 1 showing a closer view of the position and relative size of the exemplary pocket of the present invention on the right side of the pants.

FIG. 3 is a side exterior view of a different pair of pants having an exemplary utility pocket of the present invention positioned on the left side of the pants with a knife inserted therein, and showing the internal cavity of the subject pocket and the other pockets of the pants in phantom lines.

FIG. 4 is a close-up front exterior view of an embodiment showing a pocket knife clipped to the outside of a utility pocket of the present invention in a different position for accessibility.

FIG. 5 is a back exterior view of the embodiment of FIG. 1.

### DETAILED DESCRIPTION

With reference to the figures where like elements have been given like numerical designations to facilitate the reader's understanding of the present invention, a preferred embodiments of the present invention are set forth below. The enclosed figures and drawings are merely illustrative of the embodiments and represent several different views of configuring the present invention. Although specific components, materials, configurations and uses are illustrated, it should be understood that a number of variations to the components and to the configuration of those components described herein and in the accompanying figures can be made without changing the scope and function of the invention set forth herein.

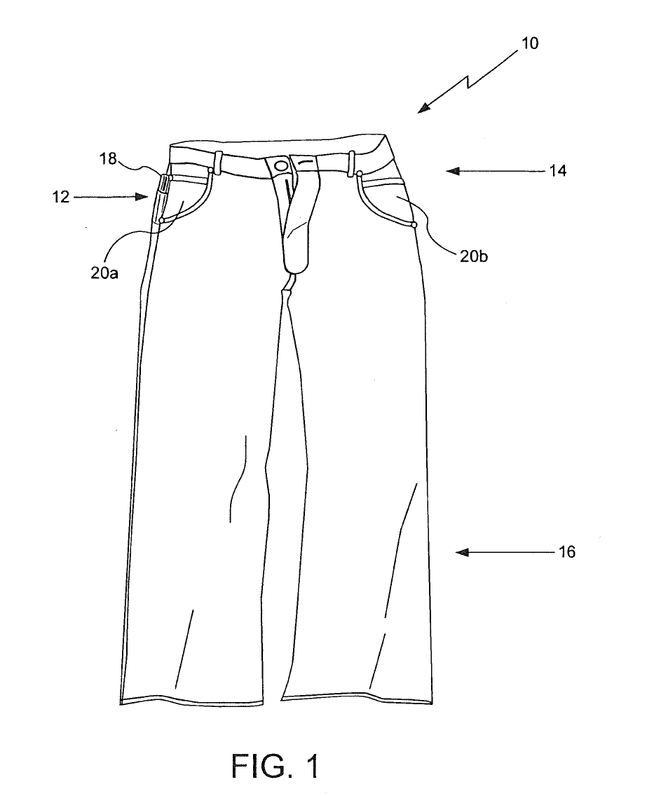

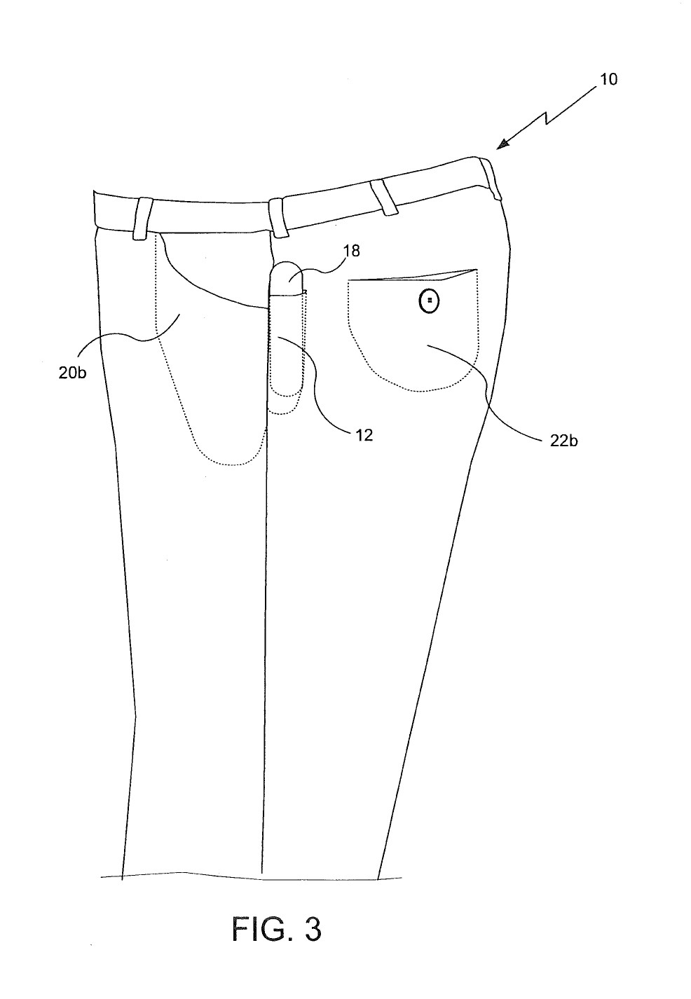

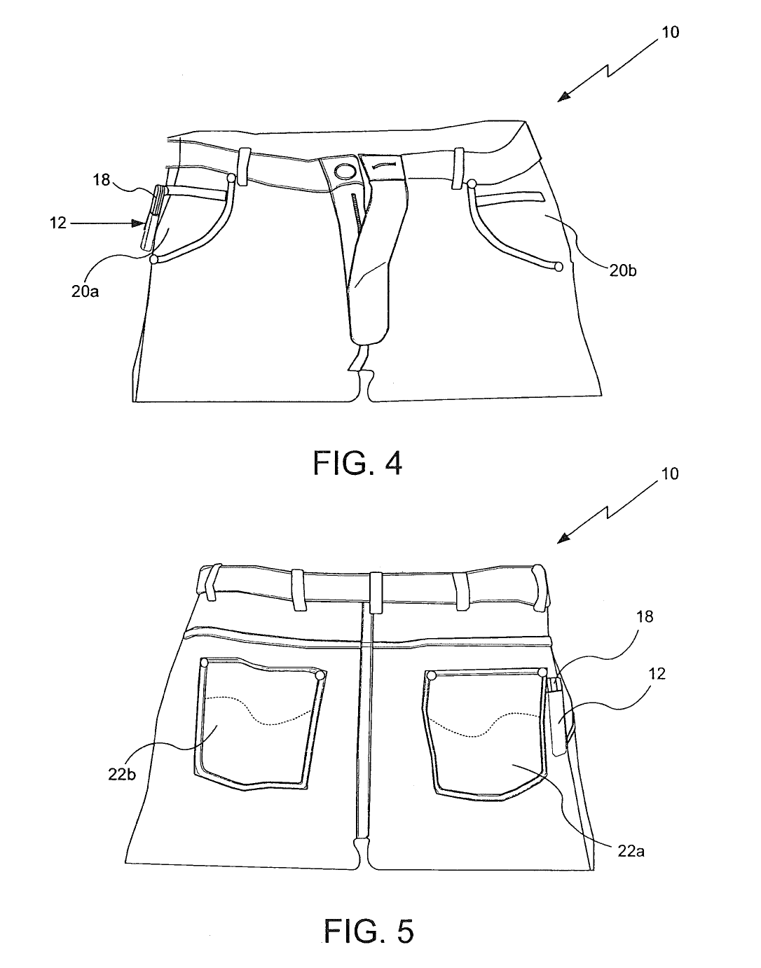

A pair of pants with a utility pocket for improved accessibility and carrying of a pocket knife or other narrow object that is manufactured out of the components and configured pursuant to the present invention is shown generally as 10 in the figures. As shown in FIG. 1, the pants 10 have an upper waist region 14 and lower leg region 16, and one or more utility pockets 12 located on one or both sides of the waist region 14. In the embodiments shown in the figures, utility pocket 12 is positioned in upper region 14 of the pants 10 so as to provide for easy accessibility of a narrow object 18 such as a pocket knife (shown in utility pocket 12) to the user when he or she is wearing pants 10. However, as will be readily understood by those skilled in the art, utility pocket 12 can be beneficially placed in either upper region 14 or lower region 16 and, in some circumstances, both areas of pants 10. Although FIGS. 1, 2, 4 and 5 show utility pocket 12 on the right side of pants 10, it can be located on either the right or left side (as shown in FIG. 3), or pockets 12 may be provided on both sides of pants 10. In a preferred embodiment, utility pocket 12 is positioned in the space between one of the front pockets 20 and the corresponding back pocket 22 of the pants 10 (i.e., whether on the right or left side). As known to those familiar with the fabrication of standard pants, the interior lining for utility pocket 12 can be made out of cotton, spandex, lycra or other materials which are suitable for producing the most efficient utility pocket 12 for different styles and sizes of the object 18. As also well known in the art, pants 10 can be made out of denim, twill, spandex, cotton or a variety of other “pant” fabrics desired by the manufacturer and wearer. Also, pant 10 can be configured with various patterns and styles, including with or without pockets 20 and 22 surrounding utility pocket 12. In one configuration, the improved pants 10 of the present invention is incorporated into economy-style pants that are particularly suitable for workers in an outdoor environment where the utility pocket 12 is essential for carrying a pocket knife 18.

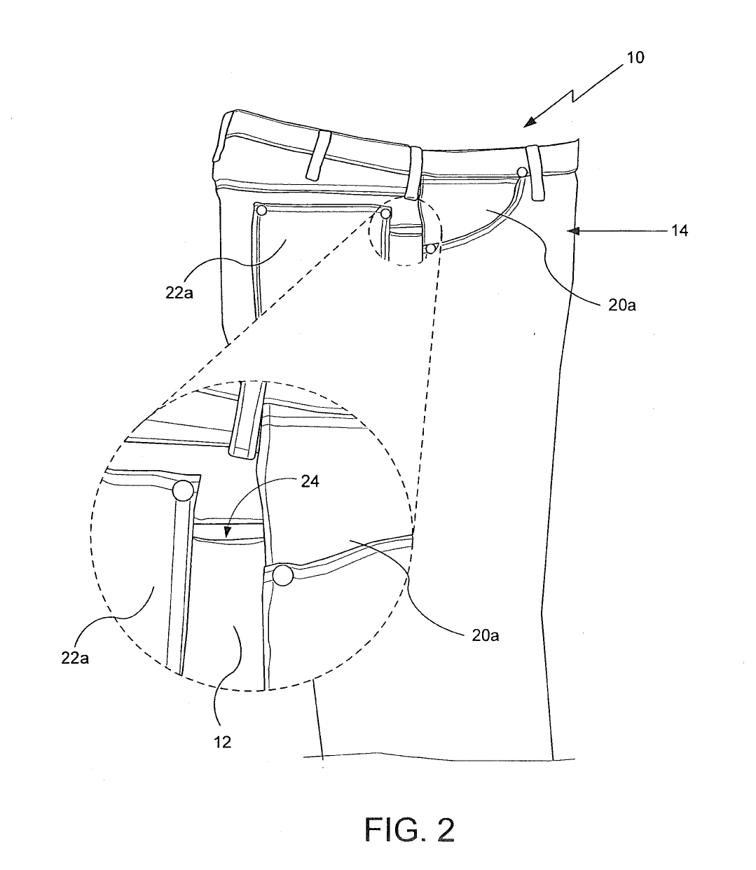

To allow the user to sit comfortably while carrying a narrow object 18 in the pocket 12, the pocket 12 is sized, positioned and configured to hold the object 18 in place in a manner that prevents object 18 from poking the user in the leg, buttocks or elsewhere while preventing the object 18 from falling out of utility pocket 12 while the user is sitting or moving. With the placement and configuration shown in the figures, namely on the side of the user's leg between the front 20 and back 22 pockets as best shown in FIG. 2, the user can sit in various positions that he or she feels comfortable, and the object 18 will still remain snug in utility pocket 12. In alternative embodiments, utility pocket 12 may be placed lower on the leg of pants 10, such as midway between the waist and knee level, or even in the lower portion 16 of pants 10. In some embodiments, and closing device such as a snap, button, zipper or hook-and-loop fabric (Velcro®) may be provided at the top opening 24 of pocket 12 to hold it closed.

As best shown in FIGS. 2 and 3, utility pocket 12 is preferably configured to be as unobtrusive as possible, having only a slit-like opening 24 leading into the pocket 12, which is primarily defined on the inside of pants 10. If desired by the user and/or manufacturer, utility pocket 12 can be more visibly defined from the outside of pants 12. As best shown in FIGS. 1 and 3, utility pocket 12 should be sized such that the object 18 (such as a pocket knife) fits snugly in utility pocket 12 with a portion of the knife 18 extending outwardly of opening 24. As such, the depth and width of utility pocket 12 can be selected for a common size of pocket knife 18. In an alternative embodiment, utility pocket 12 can be configured with a stretchable material at opening 24 that expands and retracts to snugly grab onto object 18 when in utility pocket 12. Likewise, the material used for the interior of utility pocket 12 can be selected to expand and retract for different lengths of objects 18 so as to place the object in a substantially easily reachable and removable position shown in the figures. As discussed above, the size and positioning of utility pocket 12 should be chosen such that object 18 is easily and quickly accessible to the user, yet also be configured so the object 18 does not readily fall out of utility pocket 12.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use. For instance, there are numerous components described herein that can be replaced with equivalent functioning components to accomplish the objectives of the present invention.

1. Pants having an upper waist area comprising a front left pocket and a front right pocket, a back left pocket and a back right pocket, a left side between said front left pocket and said back left pocket, a right side between said front right pocket and said back right pocket, the pants further comprising at least one additional utility pocket provided on at least one of said sides of the pants between a front and back pocket thereof, the additional pocket having a narrow top opening made of a stretchable material and an elongated interior made of a stretchable material to accommodate a small narrow object.

2. (canceled)

3. The pants of claim 1 wherein the top opening of said utility pocket further comprises a closure device.

4. The pants of claim 1 wherein the small narrow object is a pocket knife.

5. The pants of claim 1 wherein two utility pockets are provided, one on the left side of the pants between the front and back pockets thereof, and the other on the right side of the pants between the front and back pockets thereof.

6. Pants having an upper waist area and a lower leg area, the pants further comprising at least one utility pocket provided on a side of the pants, the utility pocket having a narrow top opening and an elongated interior made of a stretchable material to accommodate a small narrow object.

7. The pants of claim 6 wherein two utility pockets are provided, one on each of opposite sides of the pants.

8. The pants of claim 6 wherein the top opening of said utility pocket is made of a stretchable material.

9. The pants of claim 6 wherein the top opening of said utility pocket further comprises a closure device.

10. The pants of claim 6 wherein the small narrow object is a pocket knife.

11. The pants of claim 1 wherein the at least one additional utility pocket is located immediately adjacent to a front pocket of said pants.

12. The pants of claim 1 wherein the at least one additional utility pocket is located immediately adjacent to a back pocket of said pants.

13. The pants of claim 1 wherein the at least one additional utility pocket is located immediately adjacent to both a front pocket and to a back pocket of said pants.

14. The pants of claim 1 wherein the top opening of the additional utility pocket is about parallel to a waist band of said pants.

15. The pants of claim 1 wherein the top opening of the additional utility pocket is operable to secure a small elongated object.

16. The pants of claim 1 wherein the interior of said additional utility pocket is made of a stretchable material that is operable to secure said object.

17. The pants of claim 6 wherein the at least one additional utility pocket is located immediately adjacent to a front pocket of said pants.

18. The pants of claim 6 wherein the at least one additional utility pocket is located immediately adjacent to a back pocket of said pants.

19. The pants of claim 1 wherein the at least one additional utility pocket is located immediately adjacent to both a front pocket and to a back pocket of said pants.

20. The pants of claim 6 wherein the top opening of the additional utility pocket is about parallel to a waist band of said pants.

21. The pants of claim 8 wherein the top opening of the additional utility pocket is operable to secure a small elongated object.
